(19) United States
(12) Patent Application Publication
(10) Pub. No.: US 2016/0224023 A1
(43) Pub. Date: Aug. 4, 2016

(54) AUTOMATED PRODUCTION SYSTEM FOR MOBILE PHONE

(71) Applicant: ARIMA COMMUNICATIONS CORP., TAIPEI CITY (TW)

(72) Inventors: YINGCHE HUANG, HSINCHU COUNTY (TW); CHUN-CHIH LIEN, NEW TAIPEI CITY (TW); JENG-CHIEH CHENG, NEW TAIPEI CITY (TW)

(21) Appl. No.: 14/946,756

(22) Filed: Nov. 19, 2015

(30) Foreign Application Priority Data
Jan. 30, 2015 (TW) 104201544

(51) Int. Cl. G05B 19/418; H04M 1/24

(52) U.S. Cl. CPC G05B 19/41875; H04M 1/24; G05B 2219/32368

(57) ABSTRACT

An automated production system for mobile phones includes a plurality of mobile phone production apparatus, a plurality of mobile phone automatic test apparatus, a plurality of surface mount apparatus, a plurality of optical inspection apparatus, and at least one management module. The management module connects the mobile phone production apparatus, mobile phone automatic test apparatus, surface mount apparatus, and optical inspection apparatus by a plurality of signal cables. An automatic transportation apparatus is configured to transport a plurality of parts between the mobile phone production apparatus, the mobile phone automatic test apparatus, the surface mount apparatus, and the optical inspection apparatus. The automated production system of the instant disclose facilitates the management of the mobile phone production and test apparatus, and provides reports of the operation status and activation of the test apparatus for review, and so economizes manpower and raises the output of production.

### BACKGROUND OF THE INVENTION

1. Field of the Invention

The present invention is related to an automated production system, in particular, to an automated production system for mobile phones.

2. Description of Related Art

Cost, output of the production, and manpower are important factors for manufacturers and competition can improve these factors.

The quantity of mobile phones is increasing at an impressive rate with the development of the telecommunication industry. The mobile phones are assembled manually at the present day so it takes lots of time and the quality is unstable, so there is waste the manpower and an increase in the cost. The smart phone is the mainstream communication device, and the production process of the smart phone is complex and consumes lots of manpower so as to increase the cost of manufacture. Moreover, the cost of manpower is increasing but the selling price of phone is dropping and the profit margin is lower accordingly.

Therefore, it is desirable to propose an automated production system for mobile phones to overcome the abovementioned drawbacks.

### SUMMARY OF THE INVENTION

The object of the instant disclosure provides an automated production system for mobile phones to overcome the abovementioned drawbacks. The automated production system for mobile phones of the instant disclosure includes a plurality of mobile phone production apparatus, a plurality of mobile phone automatic test apparatus, a plurality of surface mount apparatus, a plurality of optical inspection apparatus and at least one of management module. The management module connects the mobile phone production apparatus, the mobile phone automatic test apparatus, the surface apparatus, and the optical inspection apparatus by a plurality signal cables. An automatic transportation apparatus is configured to transport a plurality of parts between the mobile phone production apparatus, the mobile phone automatic test apparatus, the surface mount apparatus, and the optical inspection apparatus.

The management module monitors the mobile phone production apparatus, the mobile phone automatic test apparatus, the surface mount apparatus and optical inspection apparatus by the signal cables, and remotely controls the operation of the mobile phone production apparatus, the mobile phone automatic test apparatus, the surface mount apparatus and optical inspection apparatus.

The automated production system for mobile phones of the invention further includes a plurality of automatic weighing apparatus, and at least one management module connected the automatic weighing apparatus by a plurality of signal cables.

The automatic weighing apparatus comprises a main body, an electronic balance disposed on the main body, a translating apparatus, and a lift apparatus. The translating apparatus and the lift apparatus are connected to the main body.

The automatic weighing apparatus has a function of code reading.

The automatic weighing apparatus with the function of code reading has a scanner connected the main body.

The automated production system for mobile phones of the invention further includes a plurality mobile phone labeling apparatus, and at least one of the management modules connects the mobile phone labeling apparatus by a plurality of signal cables.

The mobile phone labeling apparatus includes a printing apparatus, a position detecting module connects the printing apparatus, and a vehicle positioned by the position detecting module.

The automated production system for mobile phone of the invention further includes a plurality automatic film apparatus, and at least one of the management modules connected the automatic film apparatus by a plurality signal cables.

The automatic film apparatus includes a main body, a membrane collecting apparatus connected to the main body, a mold disposed in the main body, an adjusting apparatus connected to the main body and configured to adjust the position of the mold, and a detecting apparatus disposed in the main body.

At least one of the management modules monitor the status of the parts of the mobile phone production apparatus, at least one of the management module feeds the parts from a storage bin to the mobile phone production apparatus when the mobile phone production apparatus is short of the parts.

The status of parts of the mobile phone production apparatus displays on a billboard.

At least one of the management modules includes a data collecting apparatus with a database, and the data collecting apparatus is configured to collect the operation status and related data of the mobile phone automatic test apparatus.

The instant disclosure has the following advantages: the manufacturers of mobile phones could utilize the management module to manage the mobile phone product and test apparatus, and the management module provides reports of the operation status and the activation of the mobile phone production and test apparatus for review, so economizing manpower and raising the output of production.

For further understanding of the instant disclosure, reference is made to the following detailed description illustrating the embodiments and examples of the instant disclosure. The description is for illustrative purpose only and is not intended to limit the scope of the claim.

### BRIEF DESCRIPTION OF THE DRAWINGS

FIG. 1 is a function block diagram according to a first embodiment of the automated production system for mobile phone of the present invention.

FIG. 2 is a function block diagram according to a second embodiment of the automated production system for mobile phone of the present invention.

FIG. 3 is a function block diagram according to a third embodiment of the automated production system for mobile phone of the present invention.

FIG. 4 is a function block diagram according to a fourth embodiment of the automated production system for mobile phone of the present invention.

FIG. 5 is a function block diagram according to a fifth embodiment of the automated production system for mobile phone of the present invention.

FIG. 6 is a function block diagram according to a sixth embodiment of the automated production system for mobile phone of the present invention.

FIG. 7 is a function block diagram according to a seventh embodiment of the automated production system for mobile phone of the present invention.

FIG. 8 is a function block diagram according to an eighth embodiment of the automated production system for mobile phone of the present invention.

FIG. 9 is a flow chart of production process according to an embodiment of the automated production system for mobile phone of the present invention.

### DETAILED DESCRIPTION OF THE PREFERRED EMBODIMENTS

The following illustrates the embodiments and examples of the automated production system for mobile phones of the present invention. The description is for illustrative purposes only and is not intended to limit the scope of the claims.

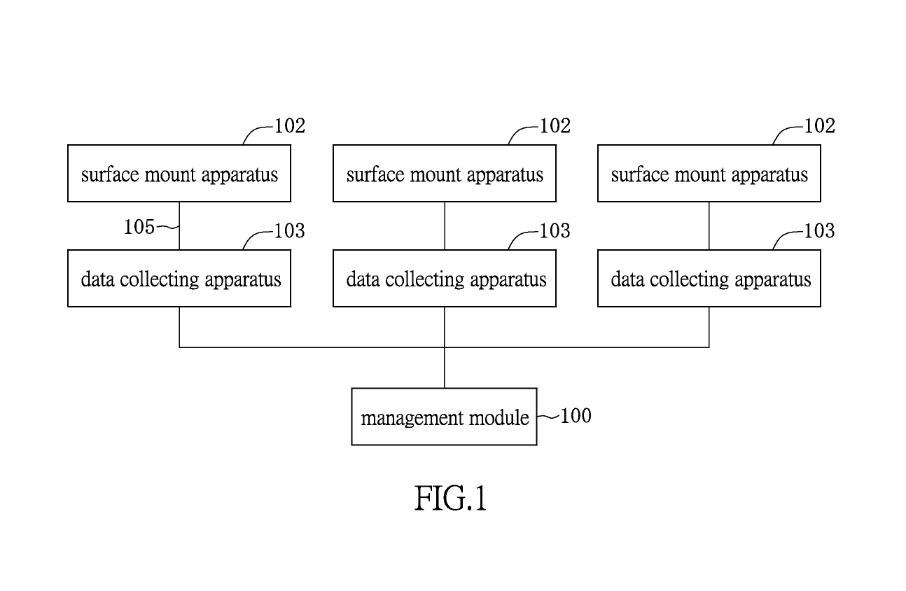

FIG. 1 is a function block diagram according to a first embodiment of the automated production system for mobile phones of the present invention. The automated production system for mobile phones according to the first embodiment of the present invention includes a plurality of surface mount apparatus 102 connected to a management module 100 by signal cables 105. The signal cables 105 may be network cables and form a local area network (LAN). Each of the surface mount apparatus 102 transmits the data (e.g. the operation status of the surface mount apparatus 102) to the corresponding data collecting apparatus 103, so the management module 100 monitors or controls the surface mount apparatus 103 accordingly. In the first embodiment, the management module 100 may be one or more processing units (e.g. computers). The management module 100 transmits the operation status of the surface mount apparatus 102 to a billboard by signal cables 105, so the billboard displays the status of the surface mount apparatus 102 in real time, and the management module 100 controls the surface mount apparatus 102 in real time accordingly. For instance, the staff could review and manage the down time, the activation, or the history of the down time of the surface mount apparatus 102 in the management module 100. The automated production system of the present invention collects the data of the surface mount apparatus 102 precisely and immediately, and the data of surface mount apparatus 102 is stored in the database of the management module 100 to facilitate the analysis of the abovementioned data.

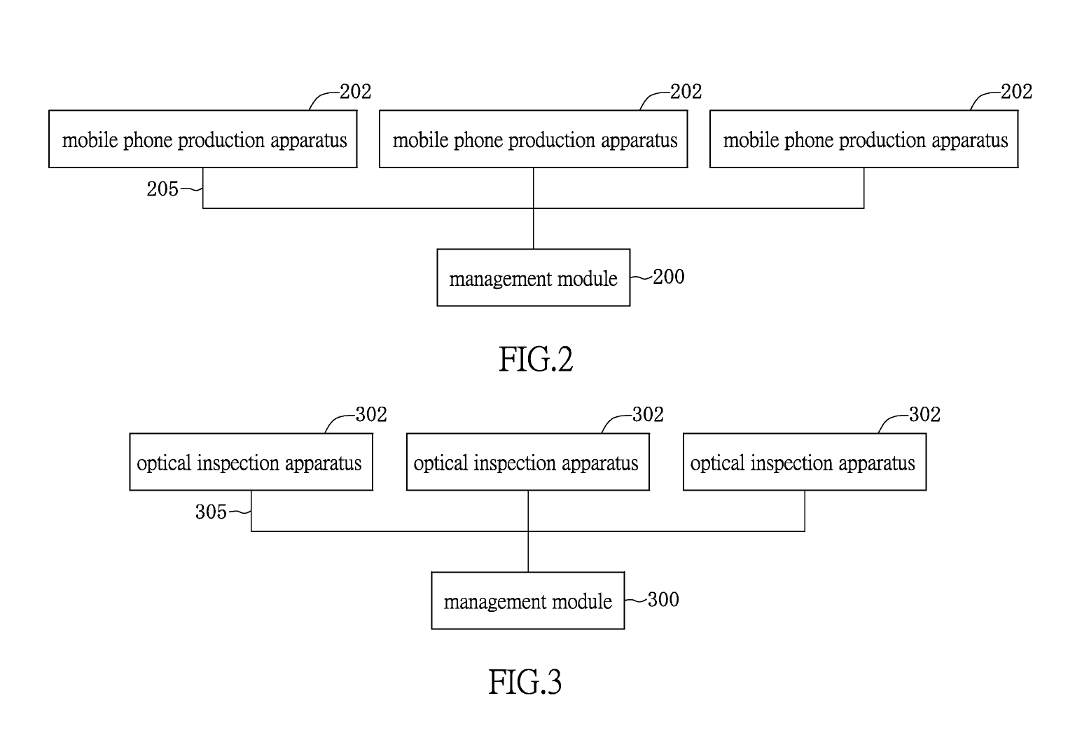

FIG. 2 is a function block diagram according to a second embodiment of the automated production system for mobile phones of the present invention. The automated production system for mobile phones according to the second embodiment of the present invention includes a plurality of mobile phone production apparatus 202 connect a management module 200 by signal cables 205. The management module 200 is called a parts entry management module. The management module 200 monitors and manages the status of parts of the mobile phone production apparatus 202, and the status of parts of the mobile phone production apparatus 202 are displayed in the billboard. The management module 200 transmits the information to the billboard when the parts of the mobile phone production apparatus 202 come up short, so the warehouse keeper or material keeper could feed the parts to the mobile phone production apparatus 202 accordingly. The foregoing parts feeding process could be done by the automated production system for mobile phone of the present invention, so the entry of parts, the preparation of parts, the feeding of parts, and the loading of parts are accomplished by the automated production system for a mobile phone of the present invention. However, the present invention is not limited to the above processes, any one of abovementioned processes could be accomplished by people or the automated production system for a mobile phone of the invention as required.

FIG. 3 is a function block diagram according to a third embodiment of the automated production system for a mobile phone of the present invention. The automated production system for a mobile phone according to the third embodiment of the present invention includes a plurality of optical inspection apparatus connected to the management module 300 by signal cables 305. The management module 300 is a remote control module. The management module 300 has the advantage as in the abovementioned embodiment such as management and collecting data in real-time. An alarm apparatus is disposed in each of the optical inspection apparatus 302 according to the third embodiment of the present invention, and the management module 300 controls the alarm apparatus directly, or the staff could check or disable the alarm of the optical inspection apparatus 302.

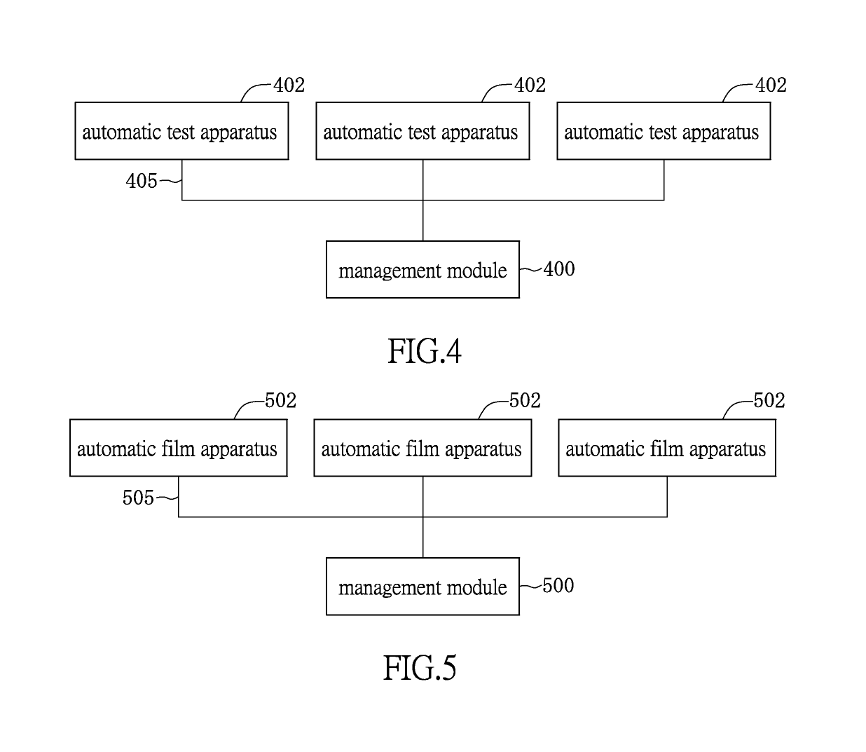

FIG. 4 is a function block diagram according to a fourth embodiment of the automated production system for a mobile phone of the present invention. The automated production system for a mobile phone according to the fourth embodiment of the present invention includes a plurality of automatic test apparatus 402 connected to the management module 400 by signal cables 405. The management module 400 monitors and manages the automatic test apparatus 402. The management module 400 has advantages of the foregoing embodiments such as collecting data and management in real-time. The difference is the automatic test apparatus 402 according to the fourth embodiment of the present invention includes robot arms and a plurality of test apparatus. The robot arms are utilized to transport the mobile phone to the test apparatus, and takes out the mobile phone from the test apparatus when the test apparatus finishes the testing process of the mobile phone. More particularly, the automatic test apparatus 402 can distinguish the mobile phones and divide them into two parts. One is the mobile phone passing the test, and another part is the mobile phone failing the test. The mobile phones failing the test are put in the working area, and the robot arms are configured to pick the mobile phone failing the test and to take it through the test apparatus once again, and if the mobile phone still cannot pass the test, then the mobile phone will be put in the manual operation area. The whole or partial process of the test process according to the fourth embodiment of the present invention can be accomplished automatically so as to economize manpower, and the management module 400 can perform analysis on the data from a data collecting apparatus with a database, and the data collecting apparatus is configured to collect the operation status and relative data of the automatic test apparatus 402.

FIG. 5 is a function block diagram according to a fifth embodiment of the automated production system for mobile phone of the present invention. The automated production system for mobile phones according to the fifth embodiment of the present invention includes a plurality of automatic film apparatus 502 connecting a management module 500 by signal cables 505. The fifth embodiment of the present invention is similar to the abovementioned embodiments. The management module 500 monitors and manages each of the automatic film apparatus 502. The difference is the automatic film apparatus 502 includes a main body, a membrane collecting apparatus connected to the main body, a mold disposed in the main body, an adjusting apparatus connected to the main body and configured to adjust the position of the mold, and a detecting apparatus disposed in the main body. The membrane collecting apparatus connects to the main body, and the mold is installed in the main body. The adjusting apparatus connects to the main body and is configured to adjust the position of the mold, and the detecting apparatus is disposed on the top surface of the main body. The management module 500 monitors and manages the operation of the automatic film apparatus, the membrane collecting apparatus, the mold the adjusting apparatus, and the detecting apparatus. The management module 500 provides reports of the management, the activation and the operation status of the automatic film apparatus 502 for review.

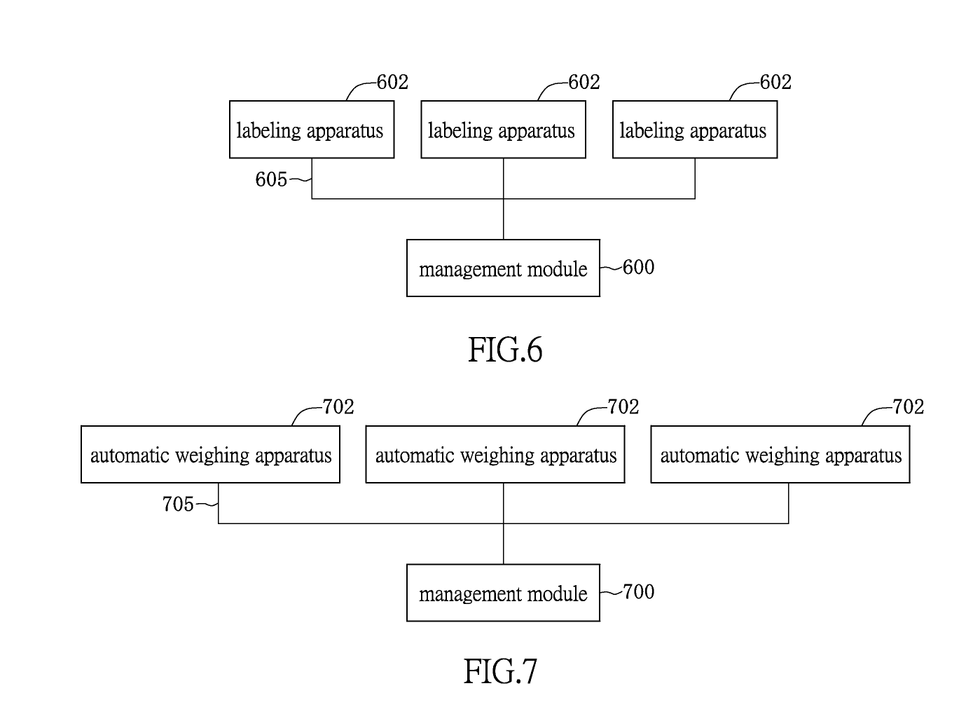

FIG. 6 is a function block diagram according to a sixth embodiment of the automated production system for mobile phone of the present invention. The automated production system for mobile phones according to the sixth embodiment of the present invention includes a plurality of labeling apparatus 602 connected to a management module 600 by signal cables 605. The sixth embodiment of the present invention is similar to the abovementioned embodiments. The management module 600 monitors and manages the labeling apparatus 602, the difference is, the labeling apparatus 602 includes a print apparatus, a position detecting module, and a vehicle. The position detecting module connects the printing apparatus, and the vehicle is positioned by the position detecting module. In the sixth embodiment of the present invention, the management module 600 provides reports of the management, the activation and the operation status of the labeling apparatus 602 for review.

FIG. 7 is a function block diagram according to a seventh embodiment of the automated production system for mobile phones of the present invention. The automated production system for mobile phones according to the seventh embodiment of the present invention includes a plurality of automatic weighing apparatus 702 connected to a management module 700 by signal cables 705. The seventh embodiment of the present invention is similar to the abovementioned embodiments, the management module 700 monitors and manages the automatic weighing apparatus 702. The difference is the automatic weighting apparatus 702 includes a main body, an electronic balance, a translating apparatus, and a lift apparatus. The electronic balance is disposed in the main body, the translating apparatus and the lift apparatus connect the main body. The automatic weighing apparatus 702 according to the seventh embodiment of the present invention has a function of code reading, and the automatic weighing apparatus with the function of code reading has a scanner connected the main body.

In the seventh embodiment of the present invention, the management module 700 provides reports of the management, the activation, and the operation status of the automatic weighing apparatus 702 for review. The measured weight data of the automatic weighing apparatus 702 are stored in the database of the management module 700 for analysis and data collecting.

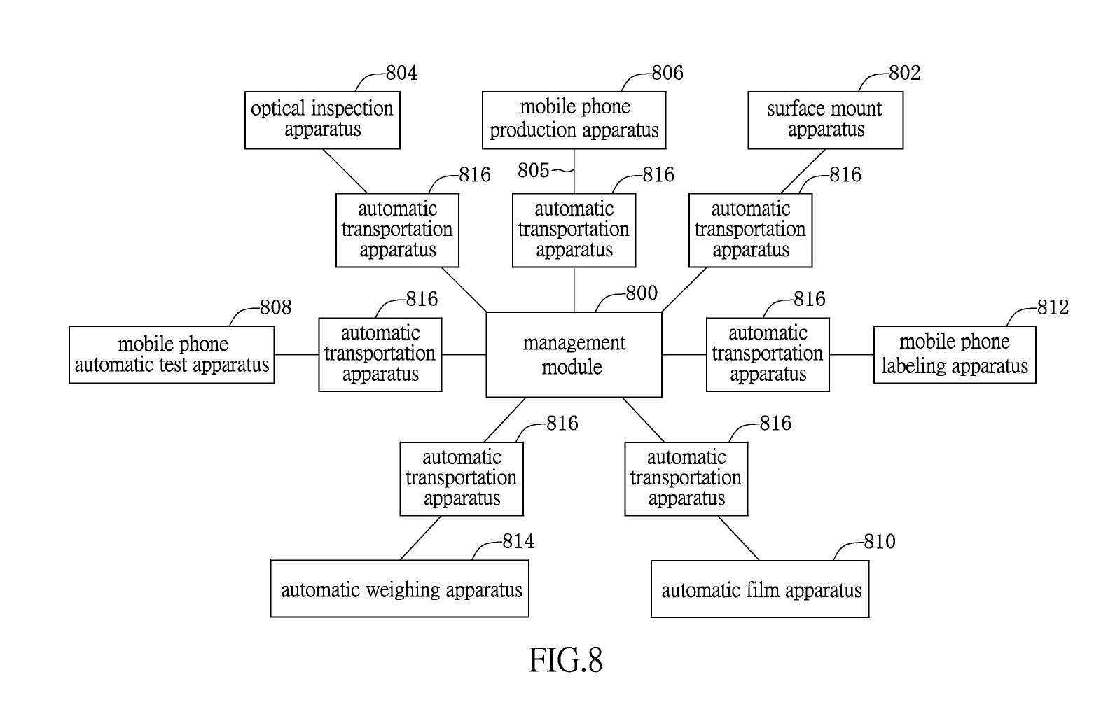

In summary, FIG. 8 is a function block diagram according to an eighth embodiment of the automated production system for mobile phones of the present invention. The automated production system for mobile phones according to the eighth embodiment of the present invention integrates the abovementioned apparatus. The automated production system for mobile phone according to the eighth embodiment includes a surface mount apparatus 802, optical inspection apparatus 804, mobile phone production apparatus 806, mobile phone automatic test apparatus 808, automatic film apparatus 810, mobile phone labeling apparatus 812, and/or automatic weighing apparatus 814 connected the management module 800 by signal cables 805, and the management module 800 manages and collects the data in real-time. An automatic transportation 816 is configured to transport a plurality of parts between the abovementioned apparatus. The automatic weighing apparatus 814 has a scanner connected to the main body for reading the code on the mobile phone. The automated production system of the eighth embodiment of the present invention is capable of economizing manpower and raising the output of the production.

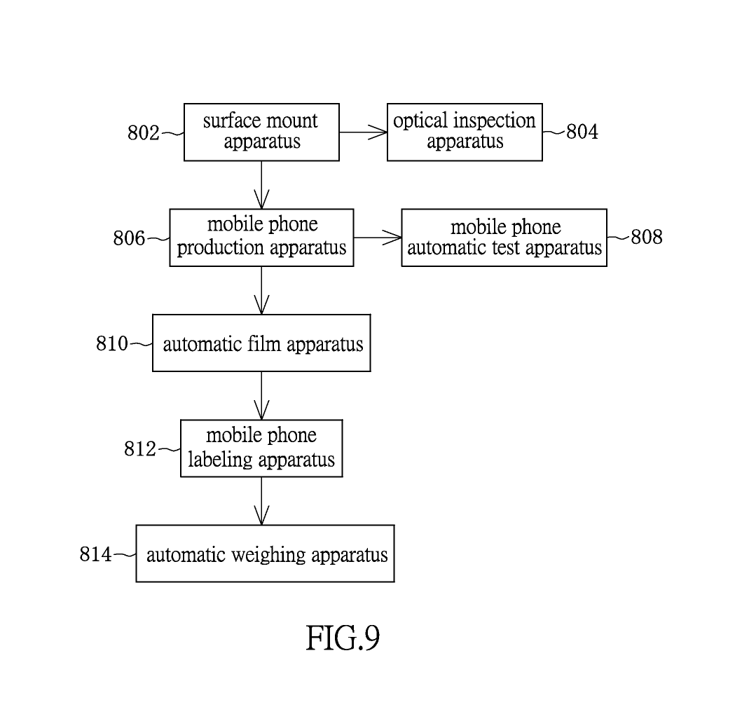

FIG. 9 is a flow chart of production process according to an embodiment of the automated production system for mobile phones of the present invention. The automated production system for mobile phones disposes the electronic components in the mobile phone by the surface mount apparatus 802, and the optical inspection apparatus 804 tests the mobile phone. The mobile phone production apparatus 806 assembles the mobile phone, and the mobile phone is transported to the mobile phone automatic test apparatus 808 for testing. The automatic film apparatus 810 pastes a membrane to the mobile phone, then the mobile phone is labeled by the mobile phone labeling apparatus 812. The mobile phone is weighed and scanned by automatic weighing apparatus 814.

In summary, the automated production system for mobile phones according to the present invention utilizes the management module to manage the mobile phone production and test apparatus, and provides reports of activation and the operation status of the mobile phone production and test apparatus, so as to economize manpower and raise the output of production.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. An automated production system for mobile phones, comprising:
a plurality of mobile phone production apparatus;
a plurality of mobile phone automatic test apparatus;
a plurality of surface mount apparatus;
a plurality of optical inspection apparatus; and
at least one of management module connected to the mobile phone production apparatus, the mobile phone automatic test apparatus, the surface mount apparatus, and the optical inspection apparatus by a plurality of signal cables, and an automatic transportation apparatus configured to transport a plurality of parts between the mobile phone production apparatus, the mobile phone automatic test apparatus, the surface mount apparatus, and the optical inspection apparatus.

2. The automated production system for mobile phones according to claim 1, wherein the management module monitors the mobile phone production apparatus, the mobile phone automatic test apparatus, the surface mount apparatus and the optical inspection apparatus by the signal cables, and remotely controls the operation of the mobile phone production apparatus, the mobile phone automatic test apparatus, the surface mount apparatus and optical inspection apparatus.

3. The automated production system for mobile phones according to claim 1, further comprising a plurality of automatic weighing apparatus, and at least one management module connected the automatic weighing apparatus by a plurality of signal cables.

4. The automated production system for mobile phones according to claim 3, wherein the automatic weighing apparatus comprises:
a main body;
an electronic balance disposed in the main body, and
a translating apparatus and a lift apparatus connected to the main body.

5. The automated production system for mobile phones according to claim 4, wherein the automatic weighing apparatus has a function of code reading.

6. The automated production system for mobile phones according to claim 5, wherein the automatic weighing apparatus with the function of code reading has a scanner connected the main body.

7. The automated production system for mobile phones according to claim 1, further comprising a plurality mobile phone labeling apparatus, and at least one of the management module connected the mobile phone labeling apparatus by a plurality of signal cables.

8. The automated production system for mobile phones according to claim 7, wherein the labeling apparatus comprises:
a printing apparatus;
a position detecting module connected to the printing apparatus; and
a vehicle positioned by the position detecting module.

9. The automated production system for mobile phones according to claim 1, further comprising a plurality automatic film apparatus, and at least one of the management module connected to the automatic film apparatus by a plurality signal cables.

10. The automated production system for mobile phones according to claim 9, wherein the automatic film apparatus comprises:
a main body;
a membrane collecting apparatus connected to the main body;
a mold disposed in the main body;
an adjusting apparatus connected to the main body and configured to adjust the position of the mold; and
a detecting apparatus disposed in the main body.

11. The automated production system for mobile phones according to claim 1, wherein at least one of the management module monitors the status of the parts of the mobile phone production apparatus, at least one of the management modules feeds the parts from a storage bin to the mobile phone production apparatus when the mobile phone production apparatus is short of the parts.

12. The automated production system for mobile phones according to claim 11, wherein the status of the parts of the mobile phone production apparatus displays on a billboard.

13. The automated production system for mobile phones according to claim 1, wherein at least one of the management modules includes a data collecting apparatus with a database, and the data collecting apparatus is configured to collect the operation status and related data of the mobile phone automatic test apparatus.
